(19) United States
(12) Patent Application Publication
(10) Pub. No.: US 2016/0002073 A1
(43) Pub. Date: Jan. 7, 2016

(54) RENEWABLE DESALINATION OF BRINES

(71) Applicant: OASYS WATER, INC., Boston, MA (US)

(72) Inventor: Marek S. Nowosielski-Slepowron, Newton, MA (US)

(21) Appl. No.: 14/767,230

(22) PCT Filed: Feb. 11, 2014
(86) PCT No.: PCT/US2014/015822

§ 371 Date: Aug. 11, 2015

Related U.S. Application Data
(60) Provisional application No. 61/785,116, filed on Mar. 14, 2013.
(60) Provisional application No. 61/764,339, filed on Feb. 13, 2013.

(51) Int. Cl. C02F 1/44; C02F 1/14; C02F 1/04

(52) U.S. Cl. CPC C02F 1/445; C02F 1/04; C02F 1/14; C02F 1/447; C02F 2103/08

(57) ABSTRACT

Separation systems and processes using osmotically driven membrane systems are disclosed and generally involve the extraction of solvent from a first solution to concentrate solute by using a second concentrated solution to draw the solvent from the first solution across a semi-permeable membrane. These systems and processes involve the integration of the osmotically driven membrane systems, such as forward osmosis, with renewable energy sources, such as solar thermal power plants or geothermal installations for the recovery of draw solutes.

### CROSS-REFERENCE TO RELATED APPLICATIONS

This application claims priority to and the benefit of U.S. Provisional Patent Application Nos. 61/764,339, filed Feb. 13, 2013; and 61/785,116, filed Mar. 14, 2013; the entire disclosures of which are hereby incorporated by reference herein in their entireties.

### FIELD OF THE TECHNOLOGY

One or more aspects relate generally to osmotic separation. More particularly, one or more aspects involve the integration of osmotically driven membrane processes (ODMP), such as forward osmosis, with renewable energy sources, such as solar thermal power plants or geothermal installations.

### BACKGROUND

Large amounts of fresh water are required for power generation. Specifically, water is consumed in the cooling process of a Rankine power cycle. Among different power generation technologies, Concentrated Solar Power (CSP) plants with wet cooling have the highest annual water consumption. To further exacerbate this problem, CSPs are located in areas of high solar irradiance, such as deserts, which have limited surface water. Some CSP plants have adopted dry cooling methods that greatly reduce water intake, but lead to increased capital costs and large efficiency losses on hot days.

Existing sea-water desalination processes utilized to provide fresh water for both municipal and industrial sources are low recovery processes. Sea Water Reverse Osmosis (SWRO) plants typically have a recovery of ˜45% —so more than half the sea water that enters the plant is returned to the sea as a concentrate. Multiple Effect Distillation (MED) and Multi-Stage Flash (MSF) plants operate at much lower recoveries, typically in the 15 to 35% range. Therefore, these plants expend energy and pre-treatment costs on bringing a great deal of water to the plant that is subsequently returned to the sea as a waste. Concentrate management is a significant issue with inland brackish water reverse osmosis (BWRO) plants. These plants can produce fresh water from brackish aquifers and surface waters, but are plagued with the problem of what to do with the concentrate that is produced. Returning the concentrate to a saline body, such as a sea or ocean, is not practical.

Low enthalpy geothermal resources provide geothermal fluids at temperatures of 150° C. and below; however, this is a generalization, as industry definitions are not consistent. These resources are less than ideal for electrical power generation, because the low temperature of the available heat results in a low thermodynamic efficiency and relatively high capital cost, and such systems would likely use an Organic Rankine Cycle. However, they are available in relatively shallow wells in many regions where higher enthalpy resources are not available.

Electrical power usage is dependent on region. But in many arid regions a significant amount of power is consumed either directly for desalination or indirectly as a reduction in power plant output due to the addition of back pressure on the steam turbine or extraction of higher pressure steam from a steam turbine, for example in an Integrated Power and Water Plant utilizing MSF or MED or a SWRO.

It is, therefore, attractive to use low enthalpy geothermal resources to desalinate water directly and avoid the significant electrical power generation inefficiencies and transmission losses, thus both reducing generation of greenhouse gases (GHGs) and displacing fossil fuel consumption. In the case of fossil fuel producers, this displaced consumption represents potential export revenue. In the context of renewable sources of energy for FO desalination, geothermal sources are very desirable in that they are not subject to diurnal or weather variations, which may negate the need for storage of heat and allow for steady operation of the desalination.

The use of geothermal resources for the desalination of water has been proposed before. Bechtel proposed a combined water and power plant in the 60's. The US Bureau of Reclamation built a plant in Holtville in 1972. This was likely with a higher enthalpy resource. Two small plants have been installed in France and Tunisia using polypropylene evaporators and condensers with operation temperature ranges of 60 to 90° C. A 2 stage Alpha Laval MED plant operating at 61° C. was piloted in the Greek Island of Kimolos with a production capacity of 80 m3/day. There does not seem to be any examples of low enthalpy geothermal desalination of a scale larger than pilot plant or installations with a high efficiency (with a significant number of effects). In general, MED is an obvious technology of choice for coupling to low enthalpy geothermal resources. In general, MSF requires too high of a thermal input temperature in order to obtain a sufficient number of stages to have an effective performance ratio, due to the adverse thermodynamics compared to MED.

It is also worth noting that at the temperatures available in low enthalpy system techniques, such as thermal vapor compression (TVC), which improve system efficiency, are not possible without an external heat pump, which would be a significant consumer of prime electrical power or a high quality heat source. Similarly, mechanical vapor compression (MVC) would use a significant amount of electricity, which may negate the benefits in the use of the geothermal resource to desalinate.

The need for, and occurrence of, sea-water desalination is highest in regions with high solar irradiance. Similarly, many in-land solar plants are located in regions of high solar irradiance that are often arid regions where access to water is limited, which hinders the solar plant operation and creates an opportunity to alleviate the local water scarcity.

### SUMMARY

Aspects of the invention relate generally to osmotically driven membrane systems and processes, including forward osmosis separation (FO), direct osmotic concentration (DOC), pressure-assisted forward osmosis (PAFO), and pressure retarded osmosis (PRO). More particularly, the invention relates to systems and methods that integrate renewable energy sources with the osmotically-driven membrane systems and processes (generally, ODMP).

Generally, the systems described herein are thermally driven brine concentrators or other types of ODMP that can recover significant amounts of water saline concentrates. The systems can produce fresh water from the waste concentrate of SWRO, MED and MSF (or directly from other water sources) and dramatically reduce the volume of the water required for, for example, a CSP plant. This water has already been treated for feed to the upstream desalination operation, and plant capacity can be increased with the existing intake and out-take structures, without increasing the pre-treatment cost, by turning a waste into a valuable product. Because the ODMP is a thermally driven process, it integrates well with solar thermal plants. Certain sources of heat can be captured from CSP plants with a very small marginal investment. Furthermore, since the ODMP can be driven by low grade (low temperature) heat, solar steam generators and solar water heaters provide a low cost approach to powering brine concentration when the brine concentration is not co-located with a CSP plant.

Described below are the estimated minimal CAPEX requirements to provide thermal power to disclosed systems for brine concentration by utilizing dumped energy and cold Heat Transfer Fluid (HTF) as sources of thermal power, as discussed in greater detail below. For a 50 MWe CSP plant, a 1300 m3/day (0.34 MGD) average capacity brine concentrating system can be virtually no OPEX utilizing dumped energy. Additional thermal power can be captured from cold HTF for only ˜$340/m3/day CAPEX investment in the solar field. These thermal power sources have no fuel costs and can be obtained with effectively zero marginal OPEX. The various systems themselves cost approximately $2,500 per m3/day capacity to install in the 3000 m3/day capacity range; however, these costs may vary depending on the application and overall size and configuration of the system. OPEX is minimal. With 25 year depreciation of capital this results in a cost of water in the $0.75 to $1 range.

Unlike all other brine concentration technologies, the present invention has the inherent capability to store desalination capacity. The basic forward osmosis process is described in the various patents and patent applications incorporated hereinbelow, but central to the production of fresh water from brines is the use of a draw solution that osmotically separates water from brines. As the draw solution is recycled in a closed loop cycle, it can be accumulated in the concentrated form during periods where thermal power input is higher and depleted during periods of lower thermal power input. Therefore, the process is inherently suited to couple with intermittent and variable thermal inputs, such as those found with renewable energy sources.

Typical CSP plants utilize a conventional steam Rankine cycle. Steam is condensed after exiting the turbine in order to improve turbine efficiency. The lower the temperature at which the heat rejected increases the efficiency of the Rankine cycle—leading to increased electrical production per unit of heat input at a given feed steam temperature. It is desirable to use cooling towers, as these can provide lower temperatures than dry cooling. But many CSP plants are, or will be, located in arid regions, where access to water resources is extremely limited. Dry cooling with air is an alternative to cooling with water consuming cooling towers. But dry cooling can reduce electricity production by 7% and increase the levelized cost of electricity (LCOE) by 10%.

Brine concentration with the disclosed osmotic systems and processes is ideally suited for reducing water consumption of cooling towers by recapturing fresh water for cooling tower make-up from saline cooling tower blown-down. Additionally, where CSP plants are located in proximity to oil and gas production or mining operations, the osmotic systems and processes can be utilized to provide fresh water to the CSP plant cooling system by desalinating saline produced waters, fracturing fluid flow back or mining wastes. In these cases, implementation of the present invention to provide the opportunity for wet cooling could reduce LCOE by as much as 10%. Water consumption for cooling may be significant: 710-950 USG/MWh. CSP plants are often located in arid regions, so on site and integrated desalination may be very beneficial by providing a source of water suitable for a cooling tower and by reusing cooling tower blow down.

In one aspect, the invention relates to a system (and its corresponding method steps) for the osmotic extraction of a solvent from a first solution. The first solution can include any of the water sources disclosed herein, including the solvent recovered from any of those sources for reuse within the system/process. The system includes a forward osmosis unit including a first chamber having an inlet fluidly coupled to a source of the first solution, a second chamber having an inlet fluidly coupled to a source of a concentrated draw solution, and a semi-permeable membrane system separating the first chamber from the second chamber and configured for osmotically separating the solvent from the first solution, thereby forming a second solution in the first chamber and a dilute draw solution in the second chamber. The system also includes a source of thermal energy from a renewable energy source and a separation system in fluid communication with the forward osmosis unit and the source of thermal energy and configured to separate the dilute draw solution into the concentrated draw solution and a solvent stream. The separation system includes a first inlet fluidly coupled to an outlet of the second chamber of the forward osmosis unit for receiving the dilute draw solution therefrom, a second inlet for receiving the source of thermal energy, a first outlet fluidly coupled to the second chamber of the forward osmosis unit for introducing the concentrated draw solution to the forward osmosis unit, and a second outlet for outputting the solvent.

In various embodiments of the foregoing aspect, the forward osmosis unit includes a plurality of semi-permeable membrane systems. The renewable energy source can include a concentrated solar energy plant or a geothermal system. The source of thermal energy can include at least one of waste heat, stored heat, or a steam source. The waste heat source can include heat rejected by a concentrated solar power plant, for example, during periods of high solar irradiance. The stored heat can include at least one of a hot heat transfer fluid, a cold heat transfer fluid, and/or a source of hot water from a concentrated solar power plant or other geothermal source. The steam source can include at least one of a portion of the steam output from a steam generator, a solar superheater, and/or a steam condenser, such as might be available between stages of a steam turbine. In some embodiments, the separation system includes a distillation module, such as a distillation column and/or a membrane distillation module; however, other types of separation systems as disclosed in the incorporated applications are contemplated and considered within the scope of the invention.

In one or more embodiments, the steam source is directly coupled to the distillation module via, for example, any necessary plumbing, valves, pumps, etc. In some embodiments, the other sources of thermal energy are used to generate steam for the separation system or otherwise provide heat for alternative draw solution recovery methods. In additional embodiments, the systems can include pre- and/or post-treatment systems in fluid communication with the source of thermal energy. In one embodiment, the system includes a pretreatment system for conditioning the first solution. In another embodiment, the system includes a post-treatment system for conditioning at least one of the second solution, the concentrated draw solution, and/or the solvent. In addition, the system can include an osmotic storage system for storing the concentrated draw solution and the solvent exiting the separation system in fluidic isolation for later reintroduction to the forward osmosis unit as the first solution and the concentrated raw solution. The system can be operated to store desalination capacity during off-peak hours (e.g., a period of low water and/or energy demand) and produce water during hours of peak water and/or energy demand.

In another aspect, the invention relates to a method of osmotically extracting a solvent from a first solution. The method includes the steps of providing a forward osmosis unit, fluidly coupling a separation system with the forward osmosis unit, and introducing a source of thermal energy from a renewable energy source to the separation system. The forward osmosis unit includes a first chamber having an inlet fluidly coupled to a source of the first solution, a second chamber having an inlet fluidly coupled to a source of a concentrated draw solution, and a semi-permeable membrane system separating the first chamber from the second chamber and configured for osmotically separating the solvent from the first solution, thereby forming a second solution in the first chamber and a dilute draw solution in the second chamber. The separation system is configured to separate the dilute draw solution into the concentrated draw solution and a solvent stream and includes an inlet fluidly coupled to an outlet of the second chamber of the forward osmosis unit for receiving the dilute draw solution therefrom, a first outlet fluidly coupled to the second chamber of the forward osmosis unit for introducing the concentrated draw solution to the forward osmosis unit, and a second outlet for outputting the solvent.

In various embodiments of the foregoing aspect, the step of introducing a source of thermal energy includes directing at least one of waste heat, stored heat, or a steam source from a concentrated solar power plant to the separation system. Generally, the stored heat includes at least one of a hot heat transfer fluid, a cold heat transfer fluid, and/or a source of hot water from a concentrated solar power plant. In some embodiments, the separation system includes at least one distillation module (e.g., a distillation column or a membrane distillation module) and the step of introducing a source of thermal energy includes directing a steam source to the distillation module. The steam source can include at least one of a portion of the steam output from a steam generator, a solar super heater, and/or a steam condenser. In additional embodiments, the step of introducing a source of thermal energy includes directing the source of thermal energy to a steam generator or other heat exchanger to provide steam to the separation system. Furthermore, the method can include introducing a portion of the source of thermal energy to at least one of a pretreatment and/or post-treatment process for conditioning at least one of the first solution, the second solution, and/or the solvent. In some embodiments, the method includes the steps of storing the solvent and the concentrated draw solution generated by the separation system in fluidic isolation for later reintroduction to the forward osmosis unit as the first solution and the concentrated draw solution for additional desalination, for example, during a peak demand for water and/or energy.

In various embodiments of the foregoing aspects, the concentrated draw solution includes ammonia and carbon dioxide in a desired molar ratio of at least one to one. However, other draw solutions are contemplated and considered within the scope of the invention, including, for example, NaCl or any of the various alternative draw solutions disclosed in PCT Patent Application No. PCT/US13/69895 (the '895 application), filed Nov. 13, 2013, the disclosure of which is hereby incorporated by reference herein in its entirety. In addition, other systems and methods for separating and recovering draw solutes and the solvent, such as those disclosed in the '895 application, are contemplated and considered within the scope of the invention. Furthermore, various pretreatment and post-treatment systems can be incorporated in the forgoing aspects of the invention. The pretreatment systems can include at least one of a heat source for preheating the first solution, means for adjusting the pH of the first solution, means for disinfection (e.g., chemical or UV), separation and clarification, a filter or other means for filtering the first solution (e.g., carbon or sand filtration or reverse osmosis), means for polymer addition, ion exchange, or means for softening (e.g., lime softening) the first solution. The post-treatment systems can include at least one of a reverse osmosis system, an ion exchange system, a second forward osmosis system, a distillation system, a pervaporator, a mechanical vapor recompression system, a heat exchange system, or a filtration system.

Still other aspects, embodiments, and advantages of these exemplary aspects and embodiments, are discussed in detail below. Moreover, it is to be understood that both the foregoing information and the following detailed description are merely illustrative examples of various aspects and embodiments, and are intended to provide an overview or framework for understanding the nature and character of the claimed aspects and embodiments. Accordingly, these and other objects, along with advantages and features of the present invention herein disclosed, will become apparent through reference to the following description and the accompanying drawings. Furthermore, it is to be understood that the features of the various embodiments described herein are not mutually exclusive and can exist in various combinations and permutations.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the invention and are not intended as a definition of the limits of the invention. For purposes of clarity, not every component may be labeled in every drawing. In the following description, various embodiments of the present invention are described with reference to the following drawings, in which:

FIG. 1 is a schematic representation of a basic system for osmotic extraction of a solvent in accordance with one or more embodiments of the invention;

FIG. 2 is a schematic representation of one application of the system of FIG. 1 in accordance with one or more embodiments of the invention;

FIG. 3 is a pictorial representation of a typical parabolic CSP plant configuration with a fossil-fuel-fired back-up system;

FIG. 4 is a pictorial representation of a typical parabolic CSP plant configuration with thermal storage;

FIG. 5 is a graphical representation of waste heat dumped during peak operating hours;

FIG. 6 is a graphical representation of an example of CSP plant performance;

FIG. 7 is a graphical representation of dumped energy for an exemplary plant;

FIGS. 8A-8D are block diagrams illustrating possible configurations for integrating osmotically driven membrane processes with renewable energy sources; and

FIG. 9 is a schematic representation of the system of FIG. 1 incorporated with various heat sources for the recovery and recycling of draw solutes in accordance with one or more embodiments of the invention.

### DETAILED DESCRIPTION

In accordance with one or more embodiments, a basic osmotic method for extracting water from an aqueous solution may generally involve exposing the aqueous solution to a first surface of a forward osmosis membrane. A second solution, or draw solution, with an increased concentration relative to that of the aqueous solution may be exposed to a second opposed surface of the forward osmosis membrane. Water may then be drawn from the aqueous solution through the forward osmosis membrane and into the second solution, generating a water-enriched solution via forward osmosis, which utilizes fluid transfer properties involving movement from a less concentrated solution to a more concentrated solution. The water-enriched solution, also referred to as a dilute draw solution, may be collected at a first outlet and undergo a further separation process to produce purified water. A second product stream, i.e., a depleted or concentrated aqueous process solution, may be collected at a second outlet for discharge or further treatment. Alternatively, the various systems and methods described herein can be carried out with non-aqueous solutions.

In accordance with one or more embodiments, a forward osmosis membrane module may include one or more forward osmosis membranes. The forward osmosis membranes may generally be semi-permeable, for example, allowing the passage of water, but excluding dissolved solutes therein, such as sodium chloride, ammonium carbonate, ammonium bicarbonate, and ammonium carbamate. Many types of semi-permeable membranes are suitable for this purpose provided that they are capable of allowing the passage of water (i.e., the solvent) while blocking the passage of the solutes and not reacting with the solutes in the solution.

In accordance with one or more embodiments, at least one forward osmosis membrane may be positioned within a housing or casing. The housing may generally be sized and shaped to accommodate the membranes positioned therein. For example, the housing may be substantially cylindrical if housing spirally wound forward osmosis membranes. The housing of the module may contain inlets to provide feed and draw solutions to the module as well as outlets for t withdrawal of product streams from the module. In some embodiments, the housing may provide at least one reservoir or chamber for holding or storing a fluid to be introduced to or withdrawn from the module. In at least one embodiment, the housing may be insulated. In yet other embodiments, the membrane(s) may be housed within a plate and frame type module. In addition, the membrane(s) or membrane module(s) may be submerged within a reservoir holding either the first solution or the second solution.

In accordance with one or more embodiments, draw solutes may be recovered for reuse. Examples of draw solute recovery processes are described in U.S. Patent Publication No. 2012/0067819 (the '819 publication), the disclosure of which is hereby incorporated herein by reference in its entirety or the '895 application. A separation system may strip solutes from the dilute draw solution to produce product water substantially free of the solutes. The separation system may include a distillation column or other thermal or mechanical recovery mechanism. Draw solutes may then be returned, such as by a recycling system, back to the concentrated draw solution. For example, gaseous solutes may be condensed or absorbed to form a concentrated draw solution. An absorber may use dilute draw solution as an absorbent. In other embodiments, product water may be used as an absorbent, for all or a portion of the absorbing of the gas streams from a solute recycling system. In addition, gas and/or heat produced as part of a waste water treatment process may be used in the draw solute recovery process.

In accordance with one or more embodiments, the first solution may be any aqueous solution or solvent containing one or more solutes for which separation, purification or other treatment is desired. In some embodiments, the first solution may be non-potable water, such as seawater, salt water, brackish water, gray water, or some industrial water. A process stream to be treated may include salts and other ionic species such as chloride, sulfate, bromide, silicate, iodide, phosphate, sodium, magnesium, calcium, potassium, nitrate, arsenic, lithium, boron, strontium, molybdenum, manganese, aluminum, cadmium, chromium, cobalt, copper, iron, lead, nickel, selenium, silver, and zinc. In some examples, the first solution may be brine, such as salt water, seawater, wastewater or other contaminated water. The first solution may be delivered to a forward osmosis membrane treatment system from an upstream unit operation, such as an industrial facility or power generation plant, or any other source such as the ocean. The second solution may be a draw solution containing a higher concentration of solute relative to the first solution. A wide variety of draw solutions may be used. For example, the draw solution may comprise a thermolytic salt solution. In some embodiments, an ammonia and carbon dioxide draw solution may be used, such as those disclosed in U.S. Patent Publication No. 2005/0145568, the disclosure of which is hereby incorporated herein by reference in its entirety. In one embodiment, the second solution may be a concentrated solution of ammonia and carbon dioxide. In at least one embodiment, the draw solution may comprise ammonia and carbon dioxide in a molar ratio of greater than 1 to 1.

In accordance with one or more embodiments, a forward osmosis separation process may comprise introducing a first solution on a first side of a semi-permeable membrane, detecting at least one characteristic of the first solution, selecting a molar ratio for a concentrated draw solution comprising two or more solute species (e.g., ammonia and carbon dioxide and their associated species) based on the at least one detected characteristic, introducing the concentrated draw solution at the selected molar ratio on a second side of the semi-permeable membrane to maintain a desired osmotic concentration gradient across the semi-permeable membrane, promoting flow of at least a portion of the first solution across the semi-permeable membrane to form a second solution on the first side of the semi-permeable membrane and a dilute draw solution on the second side of the semi-permeable membrane, introducing at least a portion of the dilute draw solution to a separation operation to recover draw solutes and a solvent stream, reintroducing the draw solutes to the second side of the semi-permeable membrane to maintain the selected concentrations and molar ratio of solute species in the concentrated draw solution, and collecting the solvent stream.

In accordance with one or more embodiments, various osmotically driven membrane systems and methods may be integrated with larger systems. In some embodiments, systems and methods may be integrated with various heat sources and water systems. In at least one embodiment, a draw solution may be fed on the inside of tubes associated with a condenser. In some embodiments, hot water from below-ground may be used in a reboiler. In other embodiments, geothermal heat, waste heat from industrial sources, solar collectors, molten salt, or residual heat in a thermal storage system may be used. In still other embodiments, diesel generators may be implemented.

The osmotically driven membrane systems discussed herein can be integrated with various renewable energy sources, such as low (and higher) grade geothermal resources, low cost solar water heaters, low cost solar steam generators, industrial waste heat such as flue gases, condensers etc., and can be used for the following applications: produced water treatment (waters co-produced with oil and gas production); mining waste waters, water production from concentrates of SWRO, MED, MSF and other sea water desalination plants; concentrate management from in-land (and others) brackish water plant, in particular BWRO; treatment of industrial wastewaters, including, but not limited to, cooling tower blow-down, boiler blow-down, process wastewater; reuse of industrial wastewaters; brine recovery in general; distributed small scale municipal drinking water production; drinking water production in general; production of water for agricultural and/or aquaculture uses; treatment of cooling tower blow-down or condensate blow-down specifically related to power production in a CSP plant; and provision of cooling water, wash-water, steam make-up or other utility water for a solar heating, solar steam generating or solar power plant.

Generally, the integration can take the form of direct use of heat for draw solution recovery, efficiency improvements with mechanical vapor compression recovery, and efficiency improvements with multiple-effects or staging of draw solution recovery. In some cases, pretreatment is required, in which case, the pretreatment process can be made more efficient by rejecting heat from the draw solute recovery process into the raw, or partially pre-treated water, to improve softening by shifting from cold softening to warm softening with improved softening kinetics and improved rate and quality of separation. One alternative to conventional solids contacting and high rate clarification softening is to use a cross flow micro-filtration softening operation. This provides a very high quality pre-treated water and can reduce chemical demand for silica reduction. Elimination of much of pre-treatment is possible with use of submerged planar or hollow fiber membranes or alternative configurations that allow seeded slurry approach of allowing precipitation onto seed crystals in solution in contact with the FO membranes. Examples of the seeded slurry approach can be found in U.S. Patent Publication Nos. 2012/0273417 and 2012/0267307, the disclosures of which are hereby incorporated herein by reference in their entireties.

Many of these resources produce heat or power that is variable with respect to time, for example, with short-term variations in solar intensity, diurnal variations and seasonal variations. This can adversely impact the thermal separation operation. Possible solutions to this issue include: the intermittent operation of the desalination process—resulting in a larger capital cost as the capacity needs to be increased to compensate for time the plant is off line; integration into the thermal storage (if available) system of the thermal plant (e.g., molten salt or thermocline storage in a CSP plant); addition of thermal storage specifically for the desalination operation, by use of molten salts, thermocline storage, or sensible heating of ceramics or other solids; and decoupling of the thermal and desalination operations by storing desalinating separation capacity by storing osmotic separation capacity by storing concentrated and diluted draw solutions, for example, continuous desalination by replenishing and depleting a store of concentrated draw solution and intermittent draw solute recovery as heat is available.

The present invention provides for low enthalpy geothermal desalination with various osmotically driven membrane processes. Generally, the use of low enthalpy geothermal desalination offers a very attractive approach to displacing the use of fossil fuels to generate thermal and electrical power to desalinate. It removes the inefficiency of power generation and transmission and allows export of the displaced fossil fuel and reduces greenhouse gas emission. In practice, there are only a few small scale (pilot plant) implementations of low enthalpy geothermal desalination. The technology used has been MED with a few effects and a low efficiency (performance ratio). MED is the obvious conventional technology selection to couple with a low enthalpy geothermal resource. However, it is unclear how efficient this process will be when coupled with the unique characteristics of geothermal fluids at the temperatures of interest and it will require significant redesign from current commercial scale technologies. The osmotically driven membrane systems disclosed herein can use direct exchange with the geothermal circuit obviating need for the capital expense, electrical demands and inefficiency of a secondary circuit. These systems may require more pre-treatment than thermal technologies, but this is offset by much higher water recoveries and reduction in capital expense for intake/outfall structures and pumping requirements. With the current status of development, the system's performance ratio compares favorably with MED, especially given efficiency ratio reduction due to MED's need for a secondary circuit and possible need for steam generation. Future improvements in the technology offer the possibility of even greater performance.

Due to the low temperature of low enthalpy geothermal resources and the boiling point rise of geothermal brines compared to water, it is not practical to effectively flash the geothermal fluid to produce steam without the use of a vacuum condenser, which is likely impractical and inefficient as it would incur an energy penalty in the form of a vacuum pump. Thermal power is obtained by sensible heat removal from the geothermal fluid; i.e., by reducing the temperature of the geothermal fluid before it is pumped into a return well. Given the capital cost of drilling geothermal and return wells, it is economical to size a titanium primary heat exchanger to a 2° C. approach temperature. Titanium would be chosen as a material of construction due to the high salinity of the geothermal brine. That means that the fluid on the other side of the heat exchanger to the geothermal fluid will exit this exchanger at 2° C. less than the exit temperature of the geothermal fluid.

Since thermal energy is removed from the geothermal fluid by reducing its temperature, it is necessary to make a significant reduction in temperature to effectively use the resource. For example, 14% more thermal power can be obtained by cooling a 100° C. geothermal fluid to 65° C. as opposed to 70° C. Thus, the lower the temperature of the heat that can be used the more thermal energy that can be extracted from a given well. Note that in these cases the temperature of the heat flow entering the system would be 63° C. or 68° C.

In some applications it may be necessary to use a secondary circuit to transfer heat to the end use of the heat (for example electrical power generation or a desalination system). This circuit may be recirculating oil, water or other heat transfer fluid. Such a secondary system has the advantage of offering the ability to store thermal energy, although thermal storage at the temperatures of interest would be capital intensive. This secondary circuit also requires the use of prime electrical energy due to the need for a recirculation pump. There is a balance between this power demand and the temperature of the heat available to the end use of the heat. Since this secondary heat transfer fluid transfers sensible heat, its temperature will decrease. Increasing the recirculation rate can reduce this temperature decrease, but with the cost of increased pumping power due to a higher flow rate and friction losses and prime power consumption. Additionally, since a secondary circuit must transfer heat into the end use system, it requires a difference in temperature between the return temperature of the secondary fluid and the heat used in the system. This temperature can be reduced with increased capital spent on this heat exchanger, and in practice will be 2° C. or greater.

The efficiency of any thermodynamic heat engine process is limited by the temperature difference between the heat input temperature and the heat rejection temperature. In the Middle East region, the heat sink temperature (sea water) can reach 32° C. in the summer. Thus a 5° C. or greater temperature loss in a secondary circuit below the geothermal fluid return temperature can have significant impact on the efficiency of any end user of the thermal power. Thus, it is desirable to use the geothermal heat directly, rather than using a secondary circuit.

Significant improvements in thermal desalination can be made with the use of some form of heat pump, for example TVC, MVC, or absorption heat pump (ABS). However, with the temperature of heat available with low enthalpy geothermal power, TVC is not possible without an additional external heat pump. Any such heat pump would use a significant amount of prime electrical energy, as would MVC or ABS, thus negating the benefit of using low enthalpy geothermal energy.

The Gained Output Ratio (GOR) is a measure of the ratio of the mass of product water produced divided by the mass of the steam input. Since the steam input to different systems can be at different temperatures and therefore enthalpy a performance ratio is often used for comparison purposes. The Performance Ratio (PR) is often defined as the number of kilograms of water produced per 2326 kJ of heat consumed.

Thermal desalination systems are very sensitive to the Top Brine Temperature (TBT) and heat transfer area in a thermal desalination system is very significant. Any reduction in heat transfer coefficient due to scaling will have a very adverse impact of system efficiency and capacity. Sulfate is present in sea water in significant amounts and calcium sulfate exhibits retrograde solubility: it will precipitate and cause scaling if sea water is heated. MSF (a flash process) separates the sea water from the heat transfer process, but MED is very sensitive to TBT as the evaporation occurs on a heat transfer surface (usually the outside of heat transfer tubes). Thus, MED operates at much lower TBTs than MSF and often is designed to operate in parallel mode, where sea water is fed in parallel to each effect, resulting in a very low ratio of product water to sea water feed.

As discussed previously, MED plants will likely run in parallel feed mode and therefore their recovery (the percentage of product water divided by feed water) will be low. Even in backward feed mode, recovery is limited. Although recoveries as high as 30% are possible in some configurations, it is likely that recovery will be in the 10-20% range. This results in the need for large intake and outfall structures (˜10-15% of plant capex) and prime energy consumption to pull in the feed and cooling water and return the concentrate. Furthermore, the heat transfer requirements of MED necessitate the use of evaporator tubes of expensive materials such as titanium, Al-Brass and cupro-nickel alloys. Aluminum is used rarely and only with very rigorous control of scaling and corrosion. The large volumes required for low pressure drop vapor flow in vacuum conditions and the use of horizontal designs result in a significant plant footprint. Capital costs for MED plants will be project specific and are in general significant. Ranges of $1000-$2000 m3/day of capacity are published for large scale plants.

Auxiliary energy inputs include pumping and the control system. Published numbers for MED plants range from 2-5 kWh/m3. These requirements do not include the power provided to the vacuum pump (steam ejector) that is needed to remove non-condensable gases. This power is normally provided by steam, but the pressure available from low enthalpy geothermal fluids is not sufficient to drive an eductor. In addition, MED has limited pretreatment requirements. The feed is often not de-aerated, which can be challenging for materials of construction at high salinity feeds. Turbidity and suspended solids are not a concern as long as there is no risk of clogging of the spray nozzles.

As discussed earlier, MED has a limited TBT to minimize adverse scaling on the heat transfer tubing. Since heat removal from geothermal requires a reduction in temperature, the geothermal fluid cannot be used directly in the first effect, as the high temperature would cause scaling. This results in the need for a secondary circuit and direct use of the heat is not possible. Additionally, the first effect is designed to utilize steam. The use of a liquid phase heat source would require a significant redesign of existing technology with an adverse capital impact due to much higher heat transfer areas required due to lower heat transfer coefficients from a liquid as opposed to condensing steam. The use of a secondary circuit and the need for steam in the first effect will have a significant impact on MED performance ratio.

The forgoing issues are some of the reasons why integrated forward osmosis systems (FO) are so preferable. Given current membrane performance and without the use of multiple effects, the system will obtain a performance ratio of 3-5. This compares favorably with MED technology since the FO can use the geothermal fluid directly, without a secondary circuit or need to generate steam. See, for example, Table 1.

TABLE 1
FO Plant Capacity for a 100 kg/s Low Enthalpy Geothermal Well

| | Geothermal Well Head Temperature | | | | | |
|---|---|---|---|---|---|---|
| | 100° C. | | 115° C. | | 130° C. | |
| Geothermal | 10,650 | KW(t) | 15,975 | KW(t) | 21,300 | KW(t) |
| Energy Flow | | | | | | |
| FO Plant | 1300 | m3/day | 2000 | m3/day | 2500 | m3/day |
| Capacity | | | | | | |

Since the sea water is desalinated via forward osmosis across a membrane, as opposed to thermally, retrograde solubility of calcium sulfate is not a concern and scaling can be controlled with the use of scale inhibitors. Thus, FO plant recoveries can exceed both MED and SWRO recoveries significantly. Additionally, because both temperatures and pressures are moderate, with the exception of the few heat exchangers, inexpensive and robust non-metallic (PVC, CPVC, FRP) materials are used. Furthermore, the FO platform can use a spiral wound membrane element that allows a very high packing factor and vertical orientation for the draw recovery column allowing a much smaller footprint. Generally, current capital cost analysis reveals that at even modest capacities FO plants compare favorably with large scale thermal plants. Auxiliary electrical energy requirements will vary depending on the particular application, but the much higher recoveries compared to an MED process result in the need to pump much lower volumes of feed water and, therefore, the electrical requirement is expected to be lower. Pre-treatment requirements for the FO platform may be more significant than for an MED plant. For open intakes a media filter would be required. However, the optional high pH operation of the FO process diminishes the potential for fouling biofilm formation or organic fouling. Thus, the rigorous pretreatment to reduce organics in SWRO plants is not required. Given the high recovery of the FO platform much less water needs pretreatment compared to lower recovery systems. Heat input into the FO desalination occurs into the product water stream. This stream is non-scaling and so the allowable TBT is much higher than in the MED process, this allows direct use of the geothermal heat. Various hybrid approaches are possible to integrate MED and FO desalination. In particular the FO plant may be fed with the cooling water return or concentrate from the MED plant, as this would require no increase in intake capacity (and capex) and no increase in pumping feed water pumping energy, while reducing discharge pumping needs.

FIG. 1 presents a schematic of a forward osmosis system/process for osmotic extraction of a solvent. A solution to be treated may contain one or more species such as salts, proteins, catalysts, microorganisms, organic or inorganic chemicals, chemical precursors or products, colloids, or other constituents. In some non-limiting embodiments, nutrient discharge by wastewater plants may be reduced with a forward osmosis system and process as illustrated.

As shown in FIG. 1, the system/process 10 includes a forward osmosis module 12. Various forward osmosis systems and processes can be used, such as those described herein and further described in U.S. Pat. Nos. 6,391,205 and 8,002,989; and U.S. Patent Publication Nos. 2011/0203994, and 2012/0267306; the disclosures of which are hereby incorporated by reference herein in their entireties. The module 12 is in fluid communication with a feed stream 20 (i.e., the first solution) and a draw solution source or stream 24. The feed water source 20 can include, for example, municipal (e.g., sewage) and/or industrial (e.g., hydraulic fracturing flow-back) wastewater, including radioactive water. The draw solution source 24 can include, for example, a saline stream, such as sea water, or another solution as described herein that can act as an osmotic agent to dewater the feed source 20 by osmosis through a forward osmosis membrane within the module 12. The module 12 outputs a stream 26 of concentrated solution from the feed source 20 that can be further processed or discarded. The module 12 also outputs a dilute draw solution 28 that can be further processed as described herein, for example, the dilute draw solution 28 can be directed to a separation unit 30 where draw solutes and a target solvent can be recovered. Generally, the separation unit 30 receives a source of thermal or mechanical energy 80 for driving the separation/recycling process.

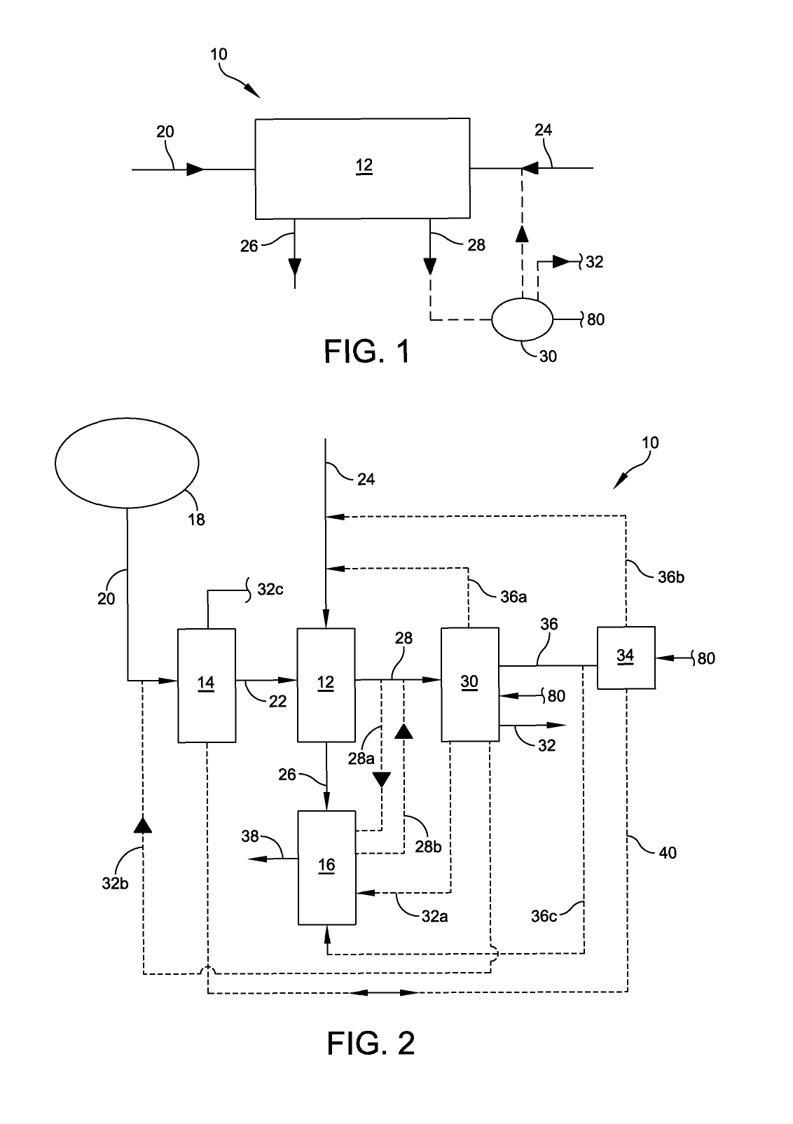

FIG. 2 represents one possible application of the system 10 for osmotic extraction of a solvent in accordance with one or more embodiments of the invention. As discussed with respect to FIG. 1, and in further detail, the system 10 includes the forward osmosis system 12 and can include one or more pre- and/or post-treatment units 14, 16. The system 10 can include any combination of pre- and/or post-treatment units 14, 16 in conjunction with one or more forward osmosis systems 12, including only pretreatment or only post-treatment. The various systems/units described herein may be interconnected via conventional plumbing techniques and can include any number and combination of components, such as pumps, valves, sensors, gauges, etc., to monitor and control the operation of the various systems and processes described herein. The various components can be used in conjunction with a controller as described hereinbelow.

In the application shown in FIG. 2, the system 10 is used to treat brackish water from an inland source 18; however, other feed sources are contemplated and considered within the scope of the invention. As shown, the feed stream 20 is directed to the pretreatment unit 14, where the feed stream is, for example, heated. Once the feed stream has been pretreated, the treated stream 22 is then directed to the forward osmosis system 12, where it provides the first solution as discussed above. Generally, the pretreatment operation can include at least one of a heat source for preheating the first solution, means for adjusting the pH of the first solution, means for disinfection (e.g., chemical or UV), separation and clarification, a filter or other means for filtering the first solution (e.g., carbon or sand filtration, nanofiltration, or reverse osmosis), heat exchange, means for polymer addition, use of an anti-scalant, ion exchange, or means for softening (e.g., lime softening) the first solution. The draw solution is provided to the forward osmosis system 12 via stream 24 to provide the osmotic pressure gradient necessary to promote transport of the solvent across the membrane, as discussed herein.

At least two streams exit the forward osmosis system 12: the concentrated feed or treated stream 26, from which solvent has been extracted; and a dilute draw stream 28, to which solvent has been added. The concentrated stream 26 can then be directed to a post-treatment unit 16 for further processing. Additional post-treatment processes may be utilized, for example, crystallization and evaporation, to further provide for zero liquid discharge. The fully processed or concentrated feed can be disposed of, recycled, or otherwise reclaimed depending on the nature of the concentrate (arrow 38). Generally, the post-treatment systems/operations can include one or more of a reverse osmosis system, an ion exchange system, additional forward osmosis processes, a distillation system, a pervaporator, a mechanical vapor recompression system, a heat exchange system, or a filtration system. Post-treatment may reduce product water salinity below that produced by a single pass forward osmosis system. In other embodiments, post-treatment may alternatively or additionally be used to remove draw solutes that would otherwise be present in a product stream. In some specific non-limiting embodiments, forward osmosis brine discharge may be post-treated using ion exchange, distillation, pervaporation, membrane distillation, aeration, biological treatment or other process to remove draw solutes that reverse diffuse into brine.

The dilute draw stream 28 can be directed to the separation system 30, where the solvent and/or draw solutes can be recovered. Optionally, the dilute draw stream 28 can also be directed to a post-treatment unit as desired for additional processing (stream 28a), for example, the dilute draw solution can be preheated before being directed to the separation system 30 (stream 28b). In one or more embodiments, the separation system 30 separates the draw solutes from the dilute draw stream 28 to produce a substantially purified solvent stream 32, for example, potable water, and a draw solute stream 36. In one or more embodiments, the solvent stream 32 can also be directed to a post-treatment unit for further processing (stream 32a) depending on the end use of the solvent. For example, the solvent can be further treated via distillation to remove additional draw solutes that may still be present in the solvent. In one or more embodiments, the draw solute stream 36 can be returned directly to the draw stream 24 (stream 36a), directed to a recycling system 34 for reintegration into the draw stream 24 (stream 36b), or directed to a post-treatment unit (stream 36c) for further processing depending on the intended use of the recovered draw solutes. In one or more embodiments, the recycling system 34 can be used in conjunction with the pretreatment unit 14 to, for example, provide heat exchange with the feed stream 20 (stream 40).

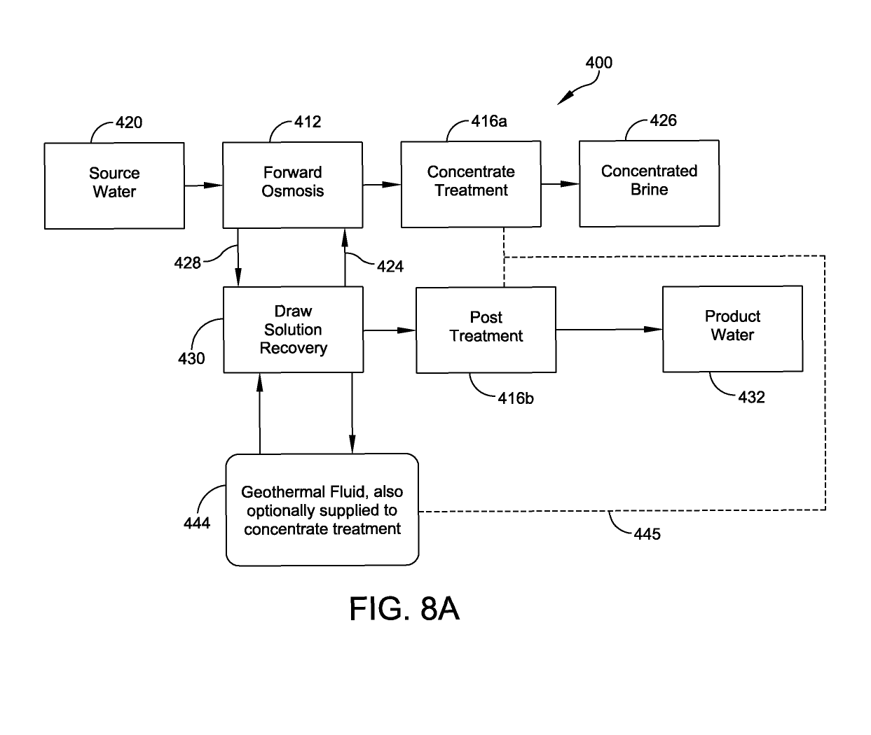

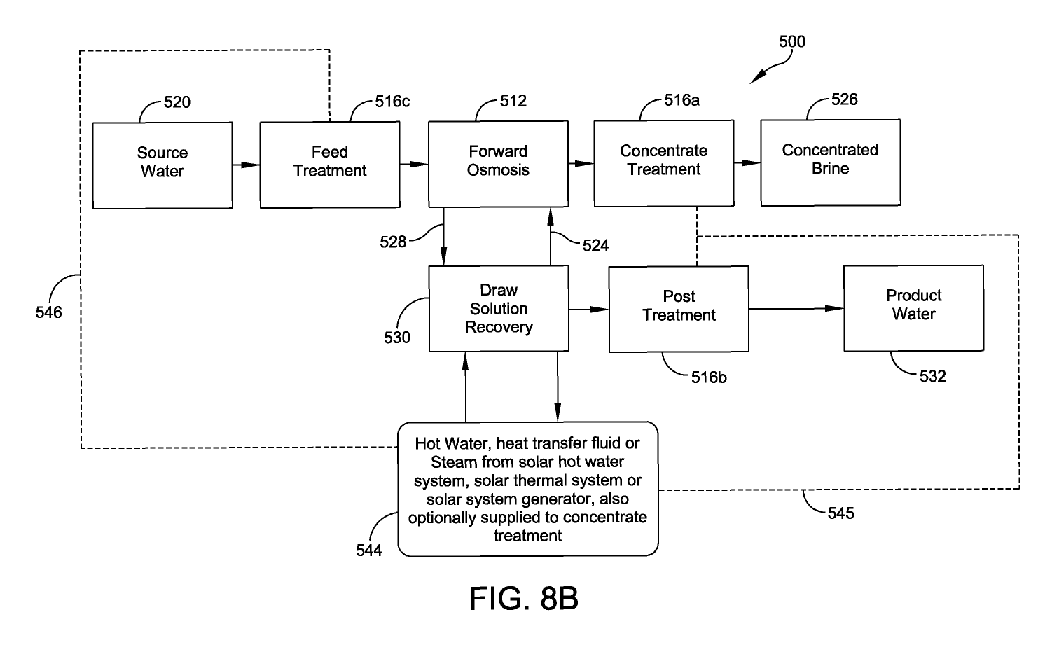

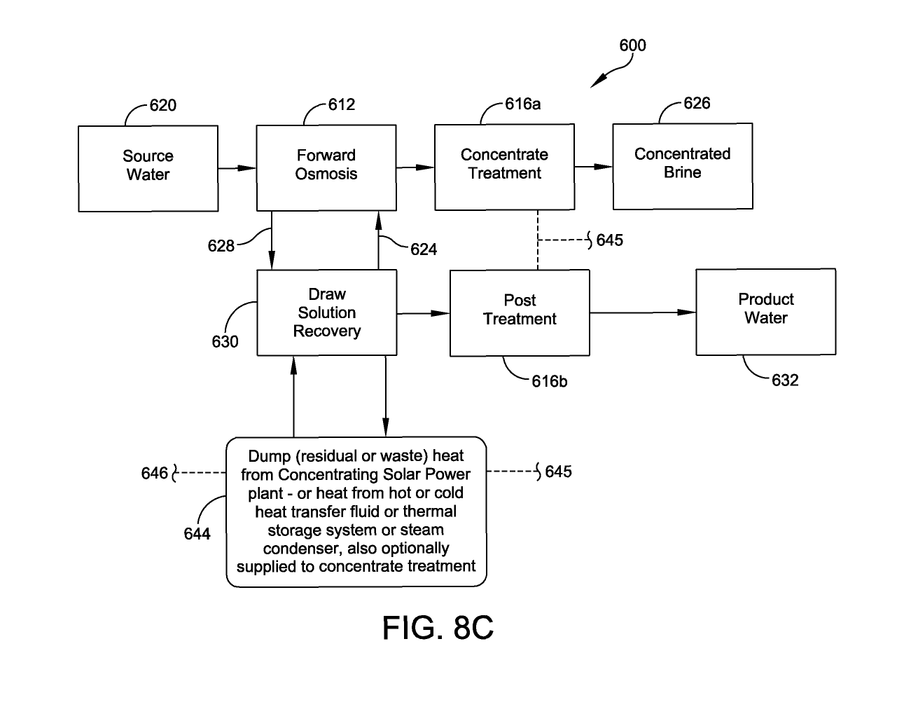

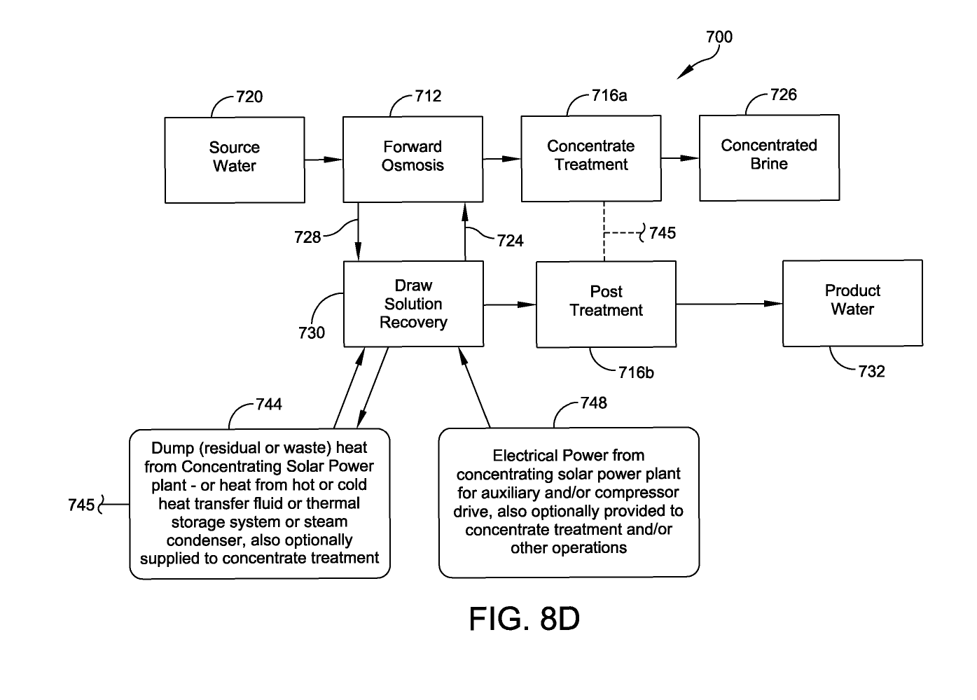

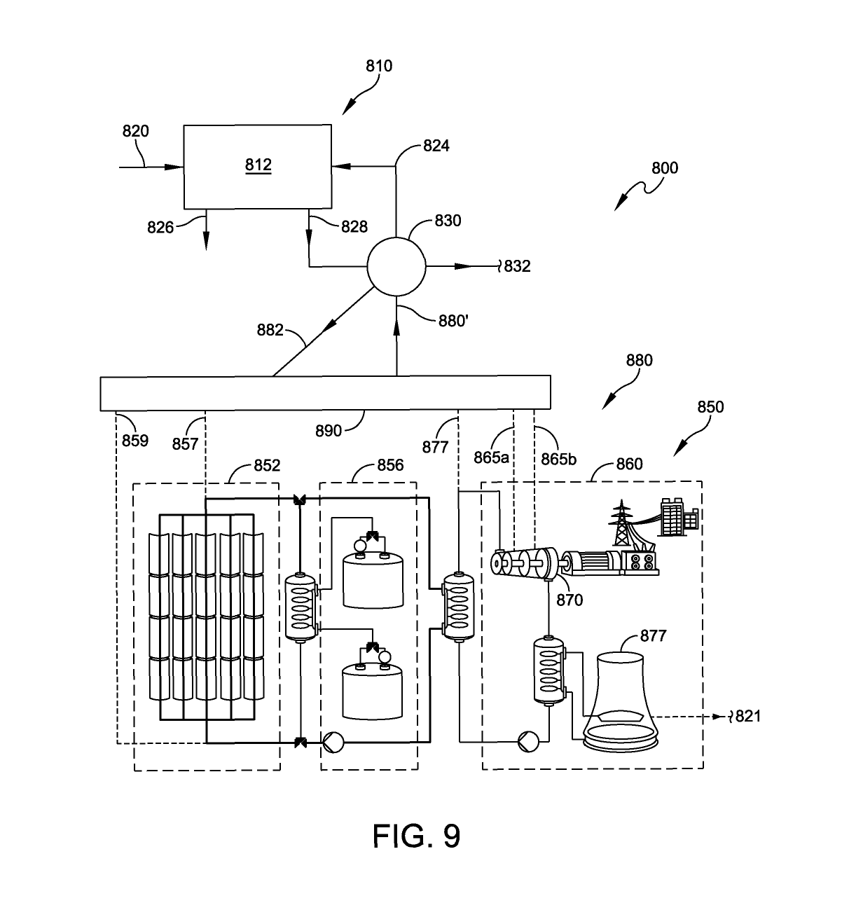

Generally, the separation system/process 30 and recycling system/process 34, along with other various pre- and post-treatment operations, require an economical heat source for, for example, the separation and recovery of draw solutes. This economical source of heat can be derived or obtained from various renewable energy sources discussed herein. FIGS. 8 and 9 depict various FO systems integrated with a CSP plant and are discussed in greater detail below.

Generally, CSP plants convert solar energy into thermal energy and then thermal energy into electrical energy. Plant peak efficiency for a parabolic trough plant is in the 14-20% range. There is efficiency loss in conversion of thermal power to electrical power. This conversion is approximately 33% efficient. It is, therefore, highly beneficial to utilize thermal energy as opposed to electrical energy to generate fresh water from brines. Additional methods of utilizing thermal power that have negligible or no impact on a CSP plant power output are discussed below. Generally, the focus of the present invention is to the integration with a parabolic trough CSP plant, as this is the most common and established technology. The various systems described herein can be integrated with other plant configurations, and similar benefits can be obtained.

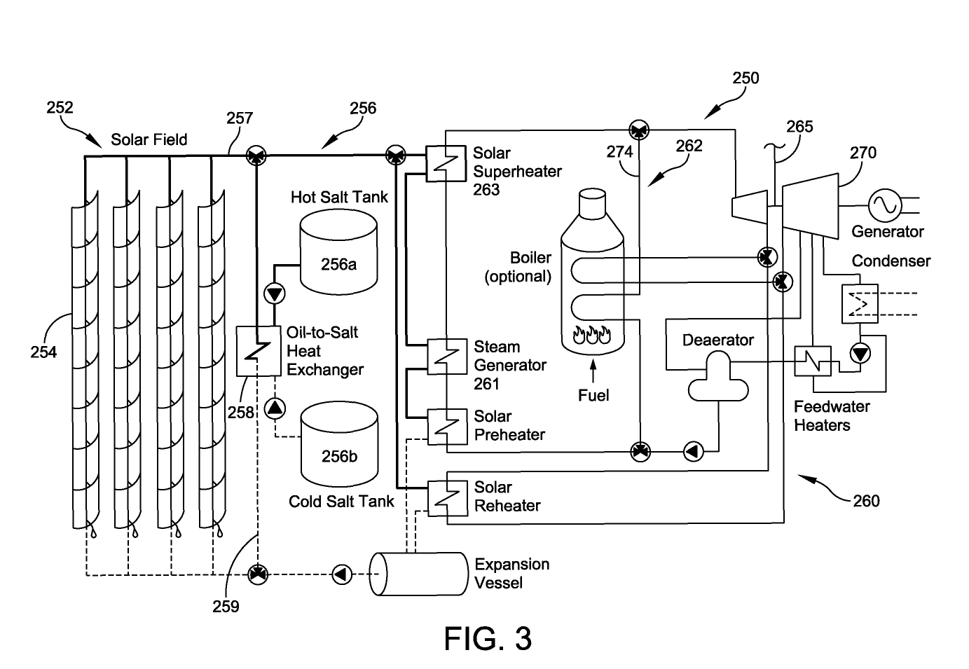

In examining current and proposed configurations of CSP plants, it is clear that there are various sources of heat for brine concentration. FIG. 3 shows a typical parabolic CSP plant configuration 250. Generally, the plant 250 includes a solar field 252 that is made up of a plurality of parabolic troughs 254 (or other collector mechanism), thermal energy storage 256 including a hot salt tank 256a and a cold salt tank 256b, along with a heat exchanger 258, and a power block 260 including a steam generation circuit 262, a steam turbine 270, and typically any necessary interface for transmitting or storing electrical energy.

The CSP plant offers several potential sources of thermal power for use with the FO system. Steam from the steam generator 261 or super heater 263 are high-grade heat sources and perfectly suitable for powering the system. However, it may not be the optimal choice as use of this heat directly reduces the electrical output of the plant. Hot Heat Transfer Fluid (HTF) 257 is another source of high-grade heat similar to the steam sources identified above. The primary difference between these two sources is that the capital cost associated with the steam generator and super-heater heat exchangers could be reduced; however, additional solar field collectors would be required or the plant output would be reduced.

In one embodiment, the system will tap into the hot HTF 257 as it enters the solar field 252, thus reducing Ti in the equation (Q=A_{C}F_{R}(S−U_{L}(Tᵢ−Tₐ)), where Q=useful power, AC=solar field size, FR=conversion efficiency, S=solar power in, UL=thermal loss coefficient, Ti=HTF inlet temp, Ta=ambient temp). This reduction will be according to Q=\dot{m}Cp (T₁-T₂) with Q being the amount of power taken from the HTF 257 and T2 the new Ti into the solar field. Since the Ti is thus lower in the equation used in 2, the entire field is more efficient. We have estimated that for a 1 MW load to be taken from the HTF, the change in temperature (T1-T2) to be on the order of 0.3° C. Decreasing the average temperature in the solar field will improve the efficiency.

Additional heat sources include the heat rejected to atmosphere in the cooling system. Typical CSP plants utilize a conventional steam Rankine cycle. Steam is condensed after exiting the turbine 270. Although this presents a viable source of thermal energy for brine concentration, it is of low grade and, depending on the application, alternative sources would likely be preferred. Fossil fuel boiler exhaust heat 274 is another suitable source of heat (depending on application), it is likely a low heat capacity source and possibly intermittent, making it less desirable.

Yet another source of thermal energy is the anti-freeze heater that may be associated with the HTF or as part of the power block 260, 360. Many CSP plants include a heater to ensure that the HTF temperature is optimized in the mornings. It is available to supply energy to other processes for the rest of the day/night. Since the capital is already sunk to the CSP plant, it can provide thermal power at only the OPEX cost, since it does not require fuel and it is of interest only in peaking or smoothing a process that is utilizing other thermal power. Sub-Optimal Loop HTF Segregation is another thermal energy option. Generally, the solar field of a CSP plant is divided into multiple parallel loops through which the HTF is pumped. As a parabolic CSP plant ages, some loops suffer greater performance losses than others due to hydrogen infiltration of hydrogen from synthetic HTFs into the vacuum envelopes of solar collectors. These sub-optimal loops will have a lower hot HTF temperature. With the addition of valving to segregate HTF from these loops, the adverse impact on steam temperature can be eliminated by diverting these loops to the FO system, where the thermal power is suitable for brine concentration.

Cold HTF 259 is typically in the range of 290-300° C. and can provide yet another source of high-grade heat suitable for brine concentration with the FO system. Additionally, since the efficiency of solar to thermal conversion in the solar field is inversely, exponentially related to the HTF temperature, removing sensible heat from the cold HTF 259 actually increases solar field efficiency and reduces the additional cost of solar collectors to compensate for this thermal power load. This source of thermal power is discussed in further detail below.

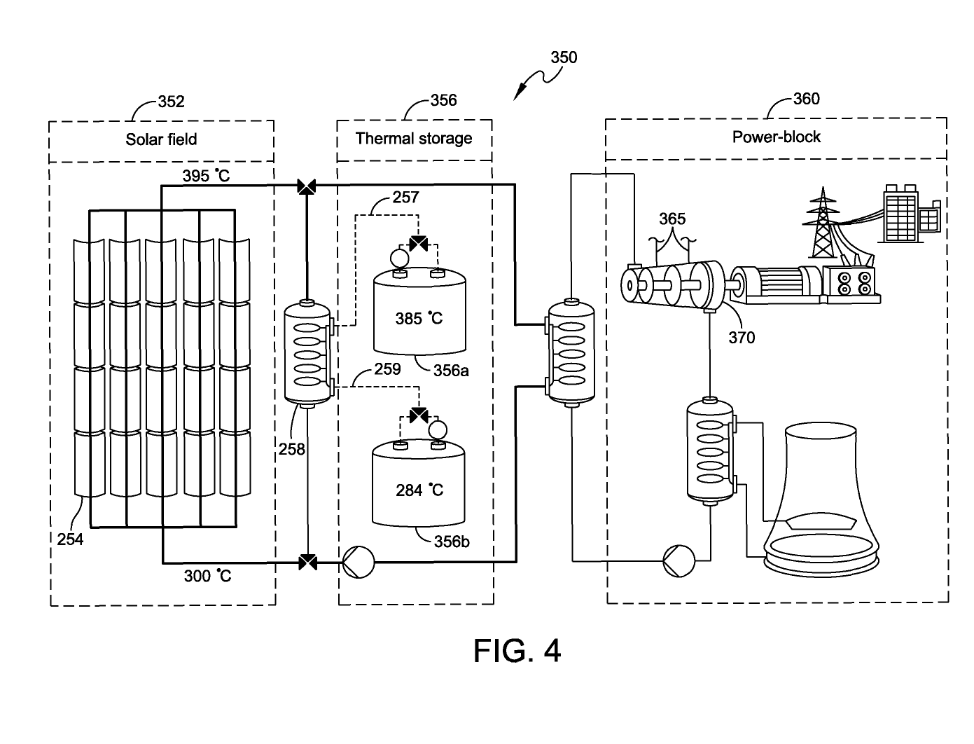

Cold HTF 259 is not actually that cold. Since it is used to generate steam, HTF is returned to the receivers at a temperature fairly close to the steam temperature (less super heating, pre-heating temperature decrease and loss to ambient). FIG. 4 depicts a CSP design with cold HTF at about 300° C. This is certainly a sufficient temperature to drive the osmotic systems described herein. Generally, any reduction in temperature of the Cold HTF will require additional apertures and solar receivers. The temperature of the HTF must be increased to a temperature that allows efficient operation of the steam turbine, but this will be more efficient collection and require less capital on a thermal power basis than heating from existing cold HTF temperatures to hot HTF temperatures. A lower temperature HTF in a receiver loses less heat through radiation, conduction and convection, and solar collection efficiency increases exponentially.

For example, for a 1 MW off-take 259a from cold HTF 259, 359 for an osmotic system from a 50 MWe electrical plant, cold HTF temperature would be reduced by 0.3° C. with an associated increase in solar plant efficiency of 0.28%. This would result in a solar field increase of ˜0.02% or ˜$40,000. A 0.3 MGD osmotic system could be powered with minimal OPEX and an addition of ˜$400,000 to the CSP solar field 252, 352. Accordingly, the use of cold HTF provides a simultaneous increase in parabolic trough thermal solar to thermal conversion efficiency and allows for providing an osmotic system with thermal power at minimal CAPEX.

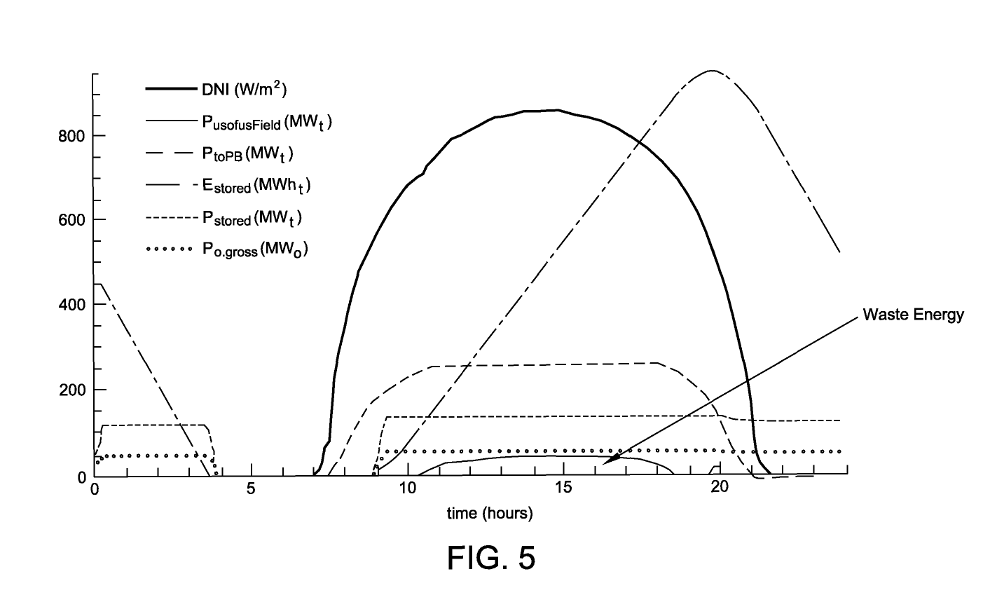

Furthermore, CSP plants with and without thermal storage are designed with a solar multiple well over one in order to increase the plant capacity factor. This results in the plant having to reject large amounts of energy during periods of higher solar irradiance (“dumped energy”). In some embodiments, the system would utilize some of the waste heat that is dumped during the peak hours in order to keep the HTF from decomposing (see the graph in FIG. 5). One method used to “dump” the energy is to de-focus the trough. The waste or “dumped” heat could be captured at the outlet of the solar field 252 via, for example, the hot or cold HTF. The amount and availability of this dumped heat will depend on plant design and location.

The solar multiple of a CSP plant is the ratio of the collector-field to the power required to operate the power cycle at full load. A plant with a solar multiple of one could provide the required thermal power to run its turbine and generator at nameplate capacity at, for example, solar noon on the summer solstice. Even plants without thermal energy storage are designed with an oversized solar collector field so that they may operate the turbine at maximum capacity for more hours of the year. This increases the plant capacity factor and generally reduces the LCOE. Plants without thermal storage have a solar multiple of 1.3 to 1.4, or even 2.0 for linear Fresnel systems. Plants with storage can have multiples of 3 to 5.

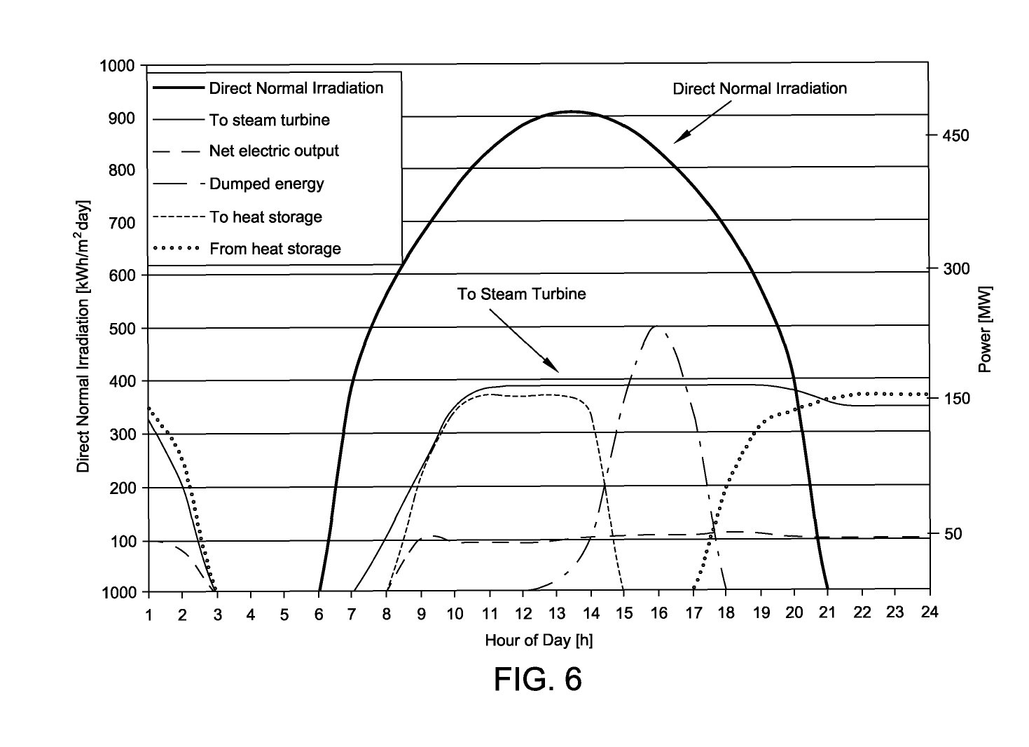

The use of a solar multiple greater than unity results in periods where a CSP plant must dump energy when the collected solar irradiance would exceed the maximum limit of thermal input to the turbine. Additionally, synthetic HTFs have a maximum operating temperature of approximately 390° C., beyond which degradation of the fluid occurs and plant operators need to “defocus” unneeded solar collectors during periods of high solar irradiance. This need to dump energy occurs even in plants with thermal storage, once the storage has reached capacity. The graph in FIG. 6 depicts over 150 MW-h of thermal energy being dumped for a 50 MWe CSP plant with 6 hours of thermal energy storage (TES) on a typical sunny day.

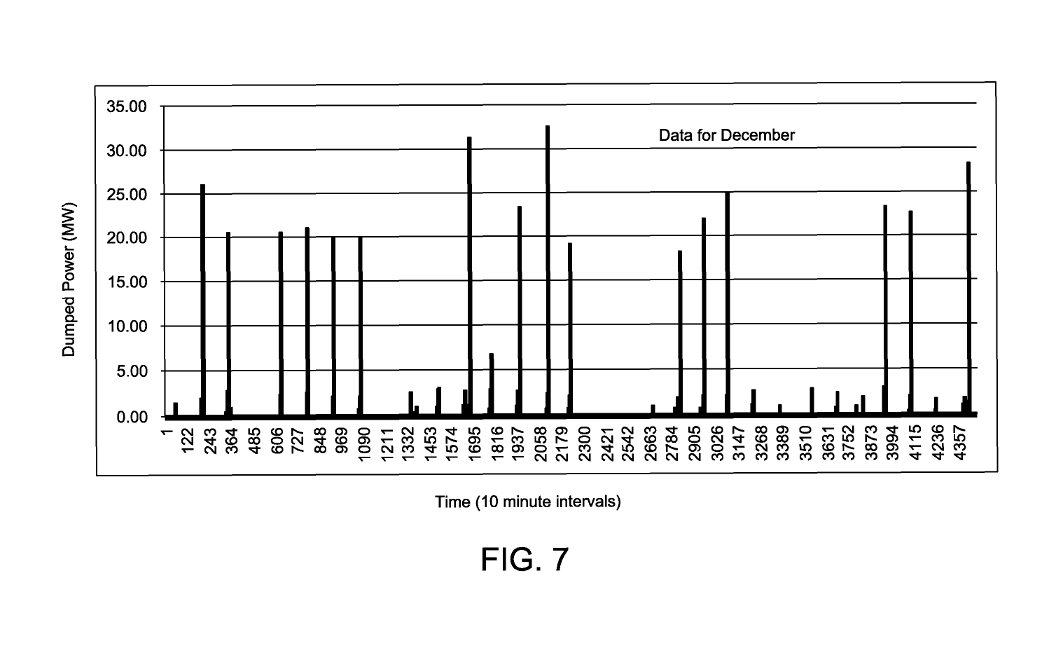

FIG. 7 depicts dumped power of an actual, installed CSP plant in Spain that dumps energy even in December, a month with low solar irradiance. This plant dumps over 95 GWh of thermal power on an annual basis. With the performance ability of the various systems described herein, this represents an average of 0.3 MGD (Millions of Gallons per day) fresh water capacity. Although this dumped energy is seasonal and sporadic, the various systems disclosed herein can smooth production by utilizing osmotic storage. The dumped energy is highest during the hot months, where both cooling water demand and local demand for water will be highest.

CSP plants dump a significant amount of energy. This energy can be utilized for brine concentration with the disclosed systems to provide fresh water to the CSP plant and other users, with no additional capital cost to the CSP plant. This provides a virtually free source of energy to provide fresh water that would otherwise be wasted. Generally, CSP plants defocus the trough to reduce the amount of energy being transferred to the HTF, so as to reduce/eliminate the excess energy that the system cannot accommodate (e.g., via system capacities, storage capabilities, and/or component ratings). With the integration of the ODMP, the trough would not necessarily need to be defocused, as this additional energy can be transferred from the HTF to the separation system. The separation system 30 can remove the excess energy/heat from the HTF (e.g., via a heat exchanger) and direct this energy/heat to the separation and recycling of draw solutes from the dilute draw solution and/or other pre- or post-treatment systems within the ODMP. After removing the excess energy/heat, the HTF is returned to the system 250, 350 in a more usable condition.

The previous sections on CSP dumped energy and cold HTF outlined the minimal CAPEX requirements to provide thermal power to the disclosed osmotic systems for brine concentration. For a 50 MWe CSP plant, a 1300 m3/day (0.34 MGD) average capacity osmotic system can be virtually no CAPEX utilizing dumped energy. Additional thermal power can be captured from cold HTF for only ˜$340/m3/day CAPEX investment in the solar field. These thermal power sources have no fuel costs and can be obtained with effectively zero marginal OPEX. In one embodiment, (for example, a brine concentrator having a capacity of 4000 barrels/day) the system itself would cost approximately $2,500 per m3/day capacity to install in the 3000 m3/day capacity range. OPEX is minimal: Auxiliary electrical demand is less than 1 kWh/m3; labor would be a marginal addition to existing CSP; chemical consumption for cleaning, draw solution replenishment and anti-scalant is minimal; and membrane replacement is similar to an RO plant. With 25 year depreciation of capital this results in a cost of water in the $0.75 to $1 range.

The specification has focused primarily on the integration of the disclosed osmotic systems with CSP plants; however, the various systems disclosed herein are ideally suited to the use of lower grade (temperature) heat sources as may be found with a variety of renewable energy sources. For example, the various systems described herein interface well with either solar steam generators or solar water heaters, which offer a much lower CAPEX alternative to CSP plants where a green field site is desired. Additionally, various hybrid approaches are possible to integrate MED and FO desalination. In particular the FO plant may be fed with the cooling water return or concentrate from the MED plant, as this would require no increase in intake capacity (and capex) and no increase in pumping feed water pumping energy, while reducing discharge pumping needs.

FIGS. 8A-8D depict various ODMP's integrated with different thermal energy sources derived from renewable energy sources. As shown in FIG. 8A, the system 400 includes one or more forward osmosis module(s) 412 in fluid communication with a water source 420 and a source of concentrated draw solution 424. The module 412 outputs a concentrated brine 426 that may have gone through an optional post-treatment system/process 416a after exiting the module 412. The module(s) 412 also output a diluted draw solution 428 that is directed to the draw solution recovery system 430 (e.g., a separation unit and a recycling unit) for re-concentrating the draw solution and recovering product water 432. In some embodiments, the product water 432 may undergo additional processing after exiting the draw solution recovery system 430 via, for example, an optional post-treatment system/process 416b, such as reverse osmosis, as discussed herein. As shown in FIG. 8A, the recovery system 430 uses a source of geothermal fluid 444 as the thermal energy for separating draw solutes and/or solvent from the dilute draw solution 428. In some embodiments, the geothermal fluid 444 is also used to further concentrate the concentrated brine, for example, via a post-treatment process for zero liquid discharge (ZLD) (see line 445).

FIG. 8B depicts a system/process 500 similar to that shown in FIG. 8A. The draw solution recovery system 530 uses one or more sources of heated fluids 544 from a CSP plant. In various embodiments, the source of heated fluid can include the heat transfer fluid (hot or cold), or steam from the solar hot water system, the solar thermal system, or the solar steam generation system. See, for example, FIG. 9. This source of thermal energy 544 can also be used with various pre- and/or post-treatment systems to further treat any of the various stream/solutions available within the ODMP. For example, the thermal energy 544 can be used to pre-heat the feed stream (pretreatment 516c and line 546) or ZLD (post-treatment 516a and line 545). See, for example, FIG. 2 for alternative uses for the thermal energy 544.

FIG. 8C depicts yet another alternative process/system 600, also similar to the processes/systems of FIGS. 8A and 8B, that uses thermal energy 644 for the draw solution recovery that includes the dump (e.g., residual or waste) heat from the CSP plant. The thermal energy 644 can also include heat from the hot or cold HTF, the steam condenser, or other thermal storage unit of the CSP plant.

FIG. 8D also depicts a process/system 700 similar to those of FIGS. 9A-9C, but that uses thermal energy 744 and optionally mechanical energy 748 to drive the draw solution recovery process/system 730. Generally, the thermal energy source 744 can be any of the sources previously described. The mechanical energy source 748 can be supplied via electrical power generated by the CSP plant to assist in the draw solution recovery process by, for example, powering a compressor or other auxiliary equipment. In addition, energy from either source 744, 748 can also be used to drive other processes of the ODMP, such as pre- and post-treatment operations, various pumps, sensors, controls, etc.

FIG. 9 depicts one exemplary system 800 that incorporates an ODMP 810 with one or more sources of thermal energy 880 from a CSP plant 850. Generally, the ODMP 810 is similar to those previously described, as is the CSP plant 850. As shown in FIG. 9, one or more sources of thermal energy, collectively 880, can be supplied to the ODMP 810 and include a bleed off of a hot HTF 857 or a cold HTF 859, steam 865a, 865b from the steam turbine 870 or associated components, and reject or dumped heat. Additional sources of thermal energy 877, such as may be available from other heat exchange devices within the plant 850. Generally, the thermal energy 880 is directed to the ODMP 810 via any necessary plumbing, valves, etc. In some embodiments, the system 800 includes an interface module 890 that includes the valves, sensors, controls, prime movers, etc., as necessary to direct a particular source of thermal energy 880, 880′ to the separation system 830. In some embodiments, multiple sources of thermal energy may be in communication with the system 810 (e.g., the separation system and/or a pre- or post-treatment process) and the interface module 890 can monitor the CSP plant and the operating conditions (e.g., ambient conditions, such as temperature and climate, plant output, energy demand, water supply, etc.) and direct the most appropriate thermal source (e.g., cold HTF or steam) to the system 810.

Generally, the system 810 receives a feed stream 820 from any of the sources previously disclosed and concentrates that stream 820 to produce a concentrated brine stream 826 via the use of a concentrated draw solution 824 to draw solvent across the membrane of the forward osmosis module 812. The system 810 uses the thermal energy 880′ as necessary (e.g., a direct feed of steam to a distillation column or via a heat exchanger) to separate solvent 832 from a dilute draw solution 828 produced by the module 812. In some embodiments, the feed stream 820 comes from a cooling tower(s) 877 associated with the CSP plant 850 (e.g., the blow-down 821) and the recovered solvent 832 can be returned to those cooling towers 877 for reuse. In various embodiments, the recovered solvent 832 can be used wherever needed within the plant 850. In some embodiments, the concentrated draw solution 824 and the solvent 832 exiting the separation system 830 can be stored in tanks for later reintroduction to the module 812. In some embodiments, the source of thermal energy 880 is derived from the steam flowing between stages of the turbine 870 (feeds 865), for example, as a direct bleed of the steam or as the thermal energy recovered by condensing the steam exiting the turbine or turbine stages 877. The “used” thermal energy 882 is typically returned to the plant 850 as, for example, a source of water from any steam condensed within the ODMP or the hot or cold HTF with the excess thermal energy removed). However, the used thermal energy 882 could be used to satisfy other energy needs within the ODMP or discarded, depending on the particular application.

In accordance with one or more embodiments, the devices, systems and methods described herein may generally include a controller for adjusting or regulating at least one operating parameter of the device or a component of the systems, such as, but not limited to, actuating valves and pumps, as well as adjusting a property or characteristic of one or more fluid flow streams through an osmotically driven membrane module, or other module in a particular system. A controller may be in electronic communication with at least one sensor configured to detect at least one operational parameter of the system, such as a concentration, flow rate, pH level, or temperature. The controller may be generally configured to generate a control signal to adjust one or more operational parameters in response to a signal generated by a sensor. For example, the controller can be configured to receive a representation of a condition, property, or state of any stream, component, or subsystem of the osmotically driven membrane systems and associated pre- and post-treatment systems. The controller typically includes an algorithm that facilitates generation of at least one output signal that is typically based on one or more of any of the representation and a target or desired value such as a set point. In accordance with one or more particular aspects, the controller can be configured to receive a representation of any measured property of any stream, and generate a control, drive or output signal to any of the system components, to reduce any deviation of the measured property from a target value.

In accordance with one or more embodiments, process control systems and methods may monitor various concentration levels, such as may be based on detected parameters including pH and conductivity. Process stream flow rates and tank levels may also be controlled. Temperature and pressure may be monitored. Membrane leaks may be detected using ion selective probes, pH meters, tank levels, and stream flow rates. Leaks may also be detected by pressurizing a draw solution side of a membrane with gas and using ultrasonic detectors and/or visual observation of leaks at a feedwater side. Other operational parameters and maintenance issues may be monitored. Various process efficiencies may be monitored, such as by measuring product water flow rate and quality, heat flow and electrical energy consumption. Cleaning protocols for biological fouling mitigation may be controlled such as by measuring flux decline as determined by flow rates of feed and draw solutions at specific points in a membrane system. A sensor on a brine stream may indicate when treatment is needed, such as with distillation, ion exchange, breakpoint chlorination or like protocols. This may be done with pH, ion selective probes, Fourier Transform Infrared Spectrometry (FTIR), or other means of sensing draw solute concentrations. A draw solution condition may be monitored and tracked for makeup addition and/or replacement of solutes. Likewise, product water quality may be monitored by conventional means or with a probe such as an ammonium or ammonia probe. FTIR may be implemented to detect species present providing information which may be useful to, for example, ensure proper plant operation, and for identifying behavior such as membrane ion exchange effects.

Those skilled in the art should appreciate that the parameters and configurations described herein are exemplary and that actual parameters and/or configurations will depend on the specific application in which the systems and techniques of the invention are used. Those skilled in the art should also recognize or be able to ascertain, using no more than routine experimentation, equivalents to the specific embodiments of the invention. It is, therefore, to be understood that the embodiments described herein are presented by way of example only and that, within the scope of the appended claims and equivalents thereto; the invention may be practiced otherwise than as specifically described.

Moreover, it should also be appreciated that the invention is directed to each feature, system, subsystem, or technique described herein and any combination of two or more features, systems, subsystems, or techniques described herein and any combination of two or more features, systems, subsystems, and/or methods, if such features, systems, subsystems, and techniques are not mutually inconsistent, is considered to be within the scope of the invention as embodied in the claims. Further, acts, elements, and features discussed only in connection with one embodiment are not intended to be excluded from a similar role in other embodiments.

What is claimed is:

1. A system for osmotic extraction of a solvent from a first solution, comprising:
a forward osmosis unit comprising:
a first chamber having an inlet fluidly coupled to a source of the first solution;
a second chamber having an inlet fluidly coupled to a source of a concentrated draw solution; and
a semi-permeable membrane system separating the first chamber from the second chamber and configured for osmotically separating the solvent from the first solution, thereby forming a second solution in the first chamber and a dilute draw solution in the second chamber;
a source of thermal energy from a renewable energy source; and
a separation system in fluid communication with the forward osmosis unit and the source of thermal energy and configured to separate the dilute draw solution into the concentrated draw solution and a solvent stream, the separation system comprising:
a first inlet fluidly coupled to an outlet of the second chamber of the forward osmosis unit for receiving the dilute draw solution therefrom;
a second inlet for receiving the source of thermal energy;
a first outlet fluidly coupled to the second chamber of the forward osmosis unit for introducing the concentrated draw solution to the forward osmosis unit; and
a second outlet for outputting the solvent.

2. The system of claim 1, wherein the forward osmosis unit comprises a plurality of semi-permeable membrane systems.

3. The system of claim 1, wherein the renewable energy source comprises a concentrated solar energy plant.

4. The system of claim 1, wherein the source of thermal energy comprises at least one of waste heat, stored heat, or a steam source.

5. The system of claim 4, wherein the waste heat comprises heat rejected by a concentrated solar power plant.

6. The system of claim 4, wherein the stored heat comprises at least one of a hot heat transfer fluid, a cold heat transfer fluid, and/or a source of hot water from a concentrated solar power plant.

7. The system of claim 4, wherein the steam source comprises at least one of a portion of steam output from a steam generator, a solar super heater, and/or a steam condenser of a concentrated solar power plant.

8. The system of claim 1, wherein the separation system comprises a distillation module.

9. The system of claim 8, wherein the distillation module comprises at least one of a distillation column and/or a membrane distillation module.

10. The system of claim 8, wherein the steam source is directly coupled to the distillation module.

11. The system of claim 1, wherein the source of thermal energy is used to produce steam or a mechanical energy source for use in the separation system.

12. The system of claim 1 further comprising a pretreatment system in fluid communication with the thermal energy source for conditioning the first solution.

13. The system of claim 1 further comprising a post-treatment system in fluid communication with the thermal energy source for conditioning at least one of the second solution, the concentrated draw solution, and/or the solvent.

14. The system of claim 1 further comprising an osmotic storage system for storing the concentrated draw solution and the solvent exiting the separation system in fluidic isolation for later reintroduction to the forward osmosis unit as the first solution and the concentrated raw solution.

15. A method of osmotically extracting a solvent from a first solution, the method comprising the steps of:
providing a forward osmosis unit, where the forward osmosis unit comprises:
a first chamber having an inlet fluidly coupled to a source of the first solution;
a second chamber having an inlet fluidly coupled to a source of a concentrated draw solution; and
a semi-permeable membrane system separating the first chamber from the second chamber and configured for osmotically separating the solvent from the first solution, thereby forming a second solution in the first chamber and a dilute draw solution in the second chamber;
fluidly coupling a separation system with the forward osmosis unit, wherein the separation system is configured to separate the dilute draw solution into the concentrated draw solution and a solvent stream and comprises:
an inlet fluidly coupled to an outlet of the second chamber of the forward osmosis unit for receiving the dilute draw solution therefrom;
a first outlet fluidly coupled to the second chamber of the forward osmosis unit for introducing the concentrated draw solution to the forward osmosis unit; and
a second outlet for outputting the solvent; and
introducing a source of thermal energy from a renewable energy source to the separation system.

16. The method of claim 15, wherein the step of introducing a source of thermal energy comprises directing at least one of waste heat, stored heat, or a steam source from a concentrated solar power plant to the separation system.

17. The method of claim 15, wherein the separation system comprises at least one distillation module and the step of introducing a source of thermal energy comprises directing a source of steam comprising at least one of a portion of a steam output from a steam generator, a solar super heater, and/or a steam condenser.

18. The method of claim 15, wherein the step of introducing a source of thermal energy comprises directing the source of thermal energy to a steam generator to provide steam to the separation system.

19. The method of claim 15 further comprising the step of introducing a portion of the source of thermal energy to at least one of a pretreatment and/or post-treatment process for conditioning at least one of the first solution, the second solution, and/or the solvent.

20. The method of claim 15 further comprising the steps of storing the solvent and the concentrated draw solution generated by the separation system in fluidic isolation for later reintroduction as the first solution and the concentrated draw solution to the forward osmosis module.
